(19) United States
(12) Patent Application Publication
(10) Pub. No.: US 2016/0267223 A1
(43) Pub. Date: Sep. 15, 2016

(54) INTEGRATED HEALTH DATA ANALYSIS SYSTEM

(71) Applicant: PRACTICE FUSION, INC., San Francisco, CA (US)

(72) Inventors: Andrew ALLEN, Weed, CA (US); Augusto de la TORRE, Berkeley, CA (US); Jonathan STACK, San Francisco, CA (US); Christopher HOGG, San Francisco, CA (US); Minh NGUYEN, San Francisco, CA (US)

(21) Appl. No.: 14/643,617

(22) Filed: Mar. 10, 2015

(51) Int. Cl. G06F 19/00

(52) U.S. Cl. CPC G06F 19/322; G06F 19/3443

(57) ABSTRACT

Embodiments relate to population health management systems and methods. To assess the health of individual patients, data about the patients may be assessed against various criteria. When the criteria is met, the patient or her physician may be notified of potential issues. Population health management may look beyond the health of an individual patient to other individuals in a common group. Embodiments may process aspects of the population health management in real or a non-real time basis.

### BACKGROUND

1. Field

This field is generally related to data analysis systems, and more particularly to systems for managing and analyzing massive quantities of population health data.

2. Background

Medical records related to a patient's health information are essential to the practice of medical care. Traditionally, medical records were paper-based documents. The emergence of electronic health record (EHR) systems offers medical professionals and patients with new functionalities that paper-based medical records cannot provide. An EHR, sometimes known as electronic medical record (EMR), is a collection of electronically stored information about an individual patient's lifetime health status and health care. EHRs may include a broad range of data, including demographics, medical history, medication and allergies, immunization status, laboratory test results, radiology images, vital signs, personal statistics like age and weight, and billing information. Many commercial EHR systems combine data from a number of health care services and providers, such as clinical care facilities, laboratories, radiology providers, and pharmacies.

EHRs are a drastic improvement over paper-based medical records. Paper-based medical records require a large amount of storage space. Paper records are often stored in different locations, and different medical professionals may each have different and incomplete records about the same patient. Obtaining paper records from multiple locations for review by a health care provider can be time consuming and complicated. In contrast, EHR data is stored in digital format, and thus can be accessed from anywhere. EHR systems significantly simplify the reviewing process for health care providers. Because data in EHRs can be linked together, EHRs vastly improve the accessibility of health records and the coordination of medical care.

EHRs also decrease the risk of misreading errors by health care professionals. Poor legibility is often associated with handwritten, paper medical records, which can lead to medical errors. EHRs, on the other hand, are inherently legible given that they are typically stored in typeface. In addition, electronic medical records enhance the standardization of forms, terminology and abbreviations, and data input, which help ensure reliability of medical records. Further, EHRs can be transferred electronically, thus reducing delays and errors in recording prescriptions or communicating laboratory test results.

The benefits of digitizing health records are substantial. Health care providers with EHR systems have reported better outcomes, fewer complications, lower costs, and fewer malpractice claim payments. But despite EHRs' potential in drastically improving the quality of medical care, only a low percentage of health care providers use EHR systems. While the advantages of EHRs are significant, they also carry concerns, including security and privacy risks, high costs, lost productivity during EHR implementation or computer downtime, and lack of EHR usability.

The Health Insurance Portability and Accountability Act (HIPAA), enacted in the U.S. in 1996, establishes rules for access, authentication, storage, auditing, and transmittal of medical records. HIPPA sets a limit as to what health information can be disclosed to third parties, and who can view a patient's medical records. HIPPA protects information in electronic medical records, such as information doctors and nurses input, recorded conversations between a doctor and a patient, and billing information. The HIPAA Security Rule, effective on Apr. 20, 2005 for most covered entities, adds additional constraints to electronic data security and the storage and transmission of private health information (PHI). Despite the regulatory restrictions, privacy and security threats are still a major risk of the current EHR systems. The convenient and fast access to patients' health records through an EHR system introduces a host of security concerns. Medical information in digital format is vulnerable to various privacy exploitations associated with hacking, computer theft, malicious attack, or accidental disclosure. According to some estimates, between 250,000 and 500,000 patients experience medical identity theft every year.

Additionally, the high cost of EHRs also significantly hinders EHR adoption. A large number of physicians without EHRs have referred to initial capital costs as a barrier to adopting EHR systems. Cost concerns are even more severe in smaller health care settings, because current EHR systems are more likely to provide cost savings for large integrated institutions than for small physician offices. During EHR technology's implementation, productivity loss can further offset efficiency gains. The need to increase the size of information technology staff to maintain the system adds even more costs to EHR usages.

Usability is another major factor that holds back adoption of EHRs. It is particularly challenging to develop user-friendly EHR systems. There is a wide range of data that needs to be integrated and connected. Complex information and analysis needs vary from setting to setting, among health care provider groups, and from function to function within a health care provider group. To some providers, using electronic medical records can be tedious and time consuming, and the complexity of some EHR systems renders the EHR usage less helpful. Some doctors and nurses also complain about the difficulty and the length of time to enter patients' health information into the system.

Under-utilization of EHR systems, despite incentives and mandates from the government and the tremendous potential of EHRs in revolutionizing the health care system, calls for better EHR systems that are secure, cost-effective, efficient, and user-friendly.

Comprehensive EHR systems can provide capabilities far beyond simply storing patients' medical records. Because EHR systems offer health care providers and their workforce members the ability to securely store and utilize structured health information, EHR systems can have a profound impact on the quality of the health care system. In Framework for Strategic Action on Health Information Technology, published on Jul. 21, 2004, the Department of Health & Human Services (HHS) outlined many purposes for EHR services. The outlined purposes include, among other things, improving health care outcomes and reducing costs, reducing recordkeeping and duplication burdens, improving resource utilization, care coordination, active quality and health status monitoring, reducing treatment variability, and promoting patients' engagement in and ownership over their own health care.

Recent legislation has set goals and committed significant resources for health information technology (IT). One of the many initiatives of the American Recovery and Reinvestment Act of 2009 (ARRA) was “to increase economic efficiency by spurring technological advances in science and health.” The Health Information Technology for Economic and Clinical Health (HITECH) Act, passed as a part of ARRA, allocated billions of dollars to adopt meaningful use of EHRs in the health care system. HITECH also mandates the Office of the National Coordinator for Health Information Technology (ONC) to define certification criteria for “Certified EHR Technology.”

EHR systems satisfying “Certified EHR Technology” criteria are capable of performing a wide range of functions, including: entry and storage, transmission and receipt of care summaries, clinical decision support, patient lists and education resources, generation of public health submission data, and patient engagement tools. Entry and storage is related to the ability to enter, access and modify patient demographic information, vital signs, smoking status, medications, clinical and radiology laboratory orders and results. Transmission and receipt of care summaries involve the ability to receive, incorporate, display and transmit transition of care/referral summaries. Clinical decision support features configurable clinical decision support tools, including evidence-based support interventions, linked referential clinical decision support, and drug-drug and drug-allergy interaction checks. Patient lists and education resources include the ability to create patient lists based on problems, medications, medication allergies, demographics and laboratory test result values, and the ability to identify patient-specific education resources based on such data elements. Generating public health submission data allows users to create electronic immunization and syndromic surveillance data files that can be submitted to public health agencies. Patient engagement tools allow medical professionals to grant patients with an online means to view, download and transmit their health information to a third party, provide patients with clinical summaries after office visits, and facilitate secure-doctor patient messaging.

### Population Health Management

Population health may describe the health outcomes of a group of individuals. Medical care is one factor that affects those outcomes. Other factors include public health interventions, aspects of the social environment (income, education, employment, social support, and culture) and of the physical environment (urban design, clean air, and water), genetics, and individual behavior.

Managing a population's health may involve the organization and management of the healthcare delivery system in a manner that makes it safer, more clinically effective, and more cost effective.

Data processing may assist in population health management. However, significant technical problems exist that limit the ability to manage and analysis large amounts of diverse data to produce effective health management indicia and notifications. Specifically, as the number of patients in the population, the criteria for assessing health outcomes, and the data involved in assessing health outcomes all grow, computing resources, such as processing power and memory, may get bogged down, hindering performance. Furthermore, existing system architectures are inadequate to support the diverse sources of data and large amounts of data needed to be processed in near real time. Improved systems and methods for managing and analyzing population health data are needed.

### BRIEF SUMMARY

In an embodiment, a system provides population health management. The system includes a computing device, and, implemented on the computing device, a clinical guideline database, a patient health data interface, a population health management engine, and a practitioner communications module. The clinical guideline database includes clinical guidelines related to one or more medical conditions. The patient health data interface receives patient health data entries. The population health management engine generates outputs based at least upon patient health data entries and clinical guidelines. Finally, the practitioner communications module presents data the population health management engine generates, and enables a practitioner to interact with the system.

Method and computer program product embodiments are also disclosed.

Further embodiments, features, and advantages of the invention, as well as the structure and operation of the various embodiments, are described in detail below with reference to accompanying drawings.

### BRIEF DESCRIPTION OF THE DRAWINGS

The accompanying drawings, which are incorporated herein and form part of the specification, illustrate the present disclosure and, together with the description, further serve to explain the principles of the disclosure and to enable a person skilled in the relevant art to make and use the disclosure.

FIGS. 1A-B are a diagrams illustrating a population health management system, according to an embodiment.

FIG. 2 is a flowchart illustrating a method for real time processing of patient health data.

FIGS. 3A-B are flowcharts illustrating methods for processing of population health data.

FIG. 4 is a user interface diagram illustrating an example notification.

FIGS. 5-8 are user interface diagrams illustrating different views of a practitioner dashboard.

FIG. 9 is a user interface diagram illustrating a patient dashboard.

FIG. 10 is a diagram illustrating an example computing device, according to an embodiment.

The drawing in which an element first appears is typically indicated by the leftmost digit or digits in the corresponding reference number. In the drawings, like reference numbers may indicate identical or functionally similar elements.

### DETAILED DESCRIPTION

Embodiments relate to population health management. To assess the health of individual patients, data about the patients may be compared against various criteria. When the criteria are met, the patient or her health practitioner may be notified of potential issues. Population health management may look beyond the health of an individual patient to other individuals in a common group. For example, a physician may be interested in the aggregate health of all patients in her practice. Similarly, other healthcare organizations—such as insurance providers or government organizations—may be interested in aggregate population data. The aggregated population health data may, for example, provide useful information about how successful different physicians are in treating their patients.

Embodiments relate to processing this population health data. In particular, some embodiments relate to dividing processing of the population health data into two different software modules. The first module processes incoming health data in real time to determine whether a criteria is met. For example, when the patient's blood pressure is measured, the blood pressure may be assessed against a criteria defining a threshold blood pressure level, above which corrective measures, such as diet or medication, should be taken. If the module determines that the criteria is met, the module may send a notification to the patient or position regarding the measurement and recommending corrective action. In this way, by assessing patient health data in real time, embodiments provide actionable data for individual patients in a timely manner.

In addition to the real time module, embodiments also include a second module that does not operate on the data in real time. Instead, this module may operate periodically and may assess the criteria against an entire population of patients. This module would then determine aggregate statistics for the population. For example, this module may determine what percentage of a particular physician's patients have high blood pressure. In this way, by determining aggregate statistics on a periodic, non-real time basis, embodiments may more efficiently process data needed to conduct population health management.

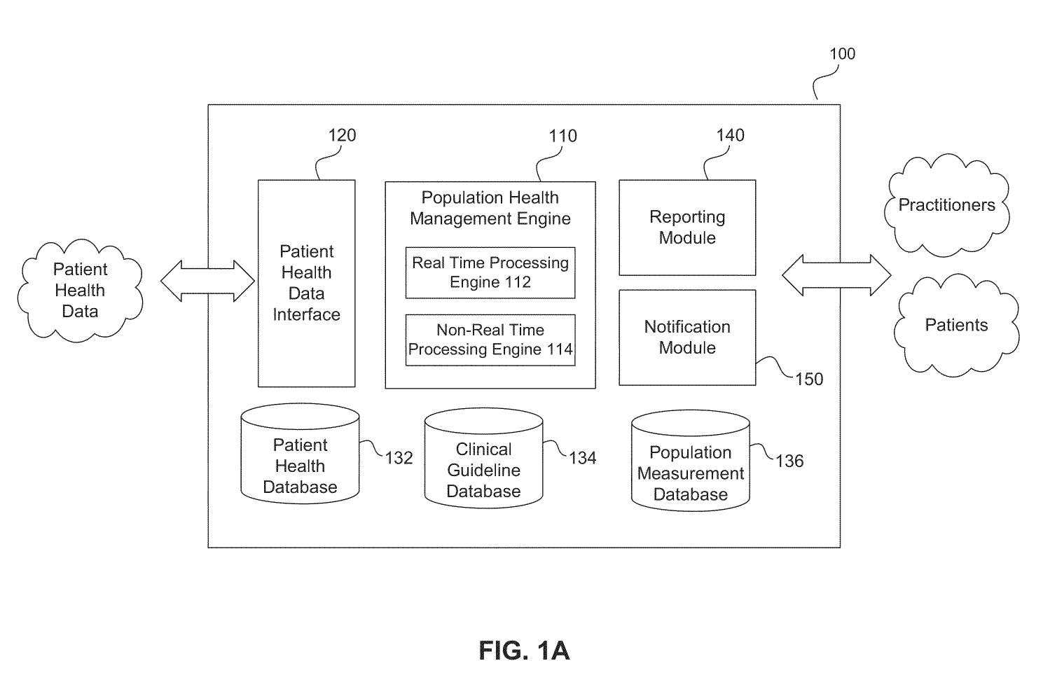

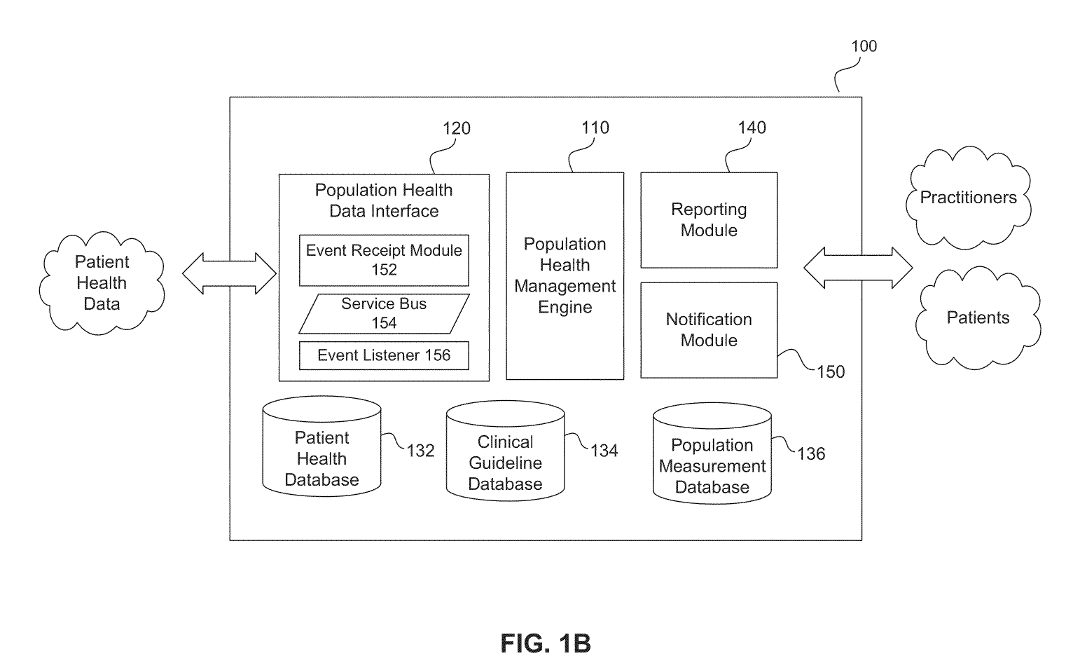

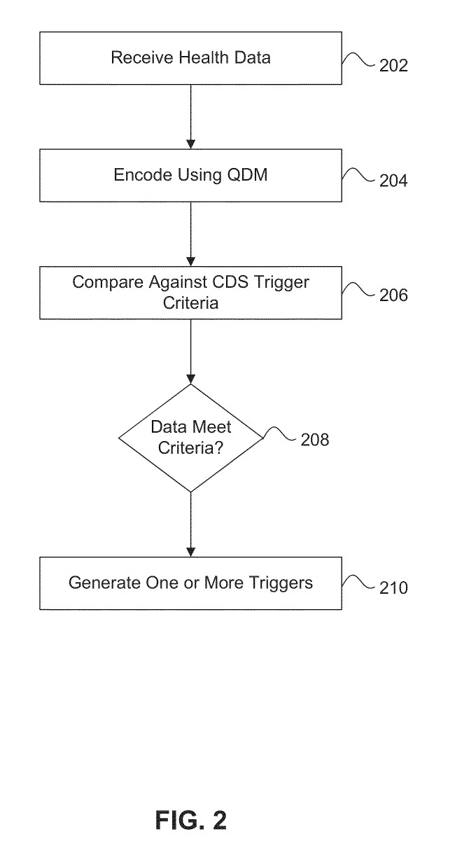

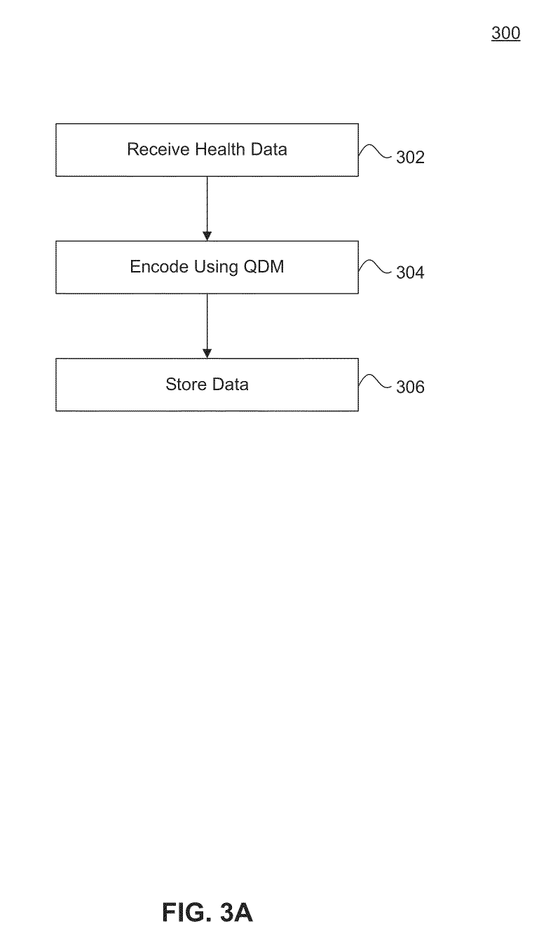

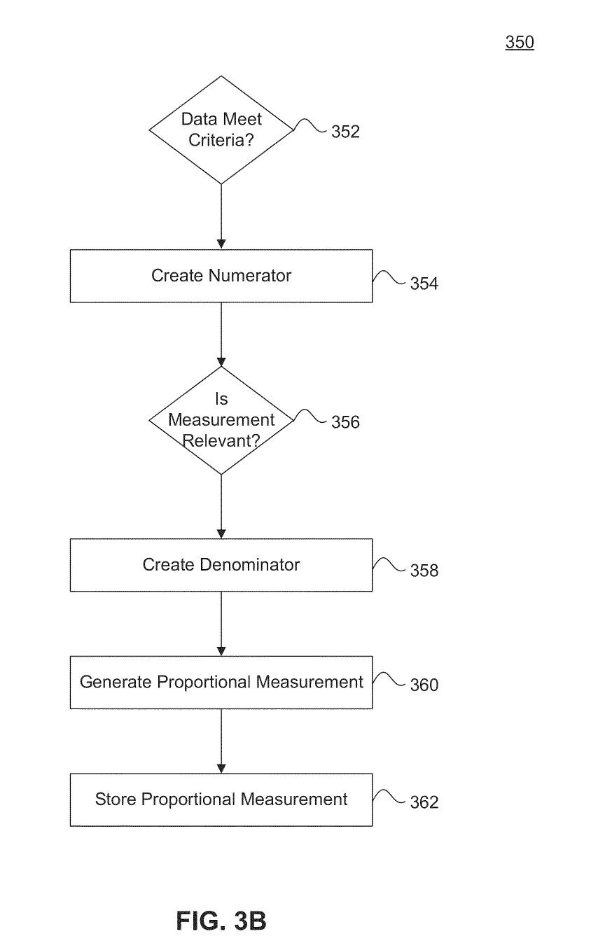

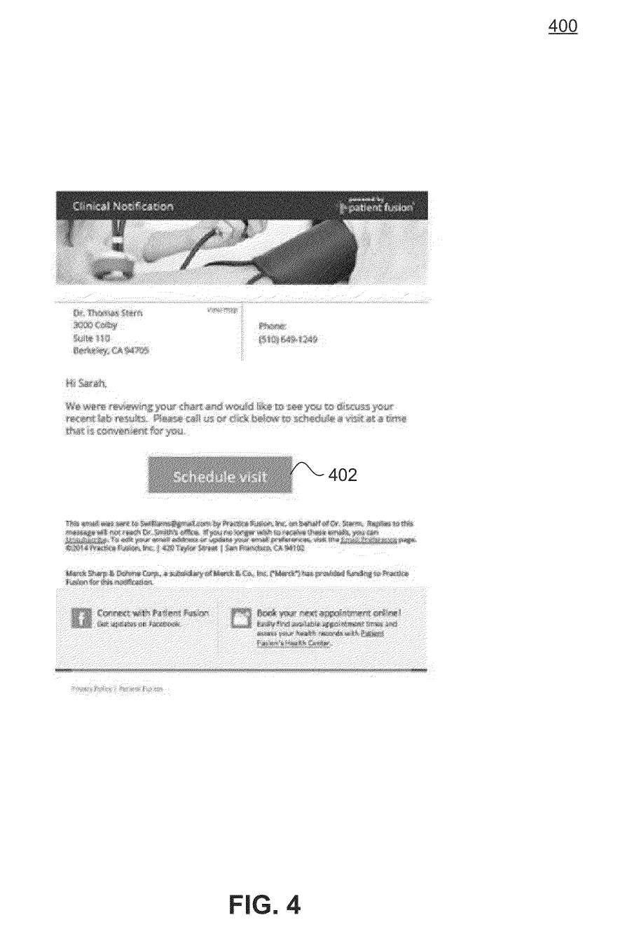

The following detailed description is divided into four sections. First, a population health management system according to embodiments is described with respect to FIGS. 1A-B. Second, methods of operating a population health management system are described with respect to FIGS. 2 and 3A-B. Third, example user interfaces are described with respect to FIGS. 4-9. Fourth and finally, an example computing device that the system may utilize is described.

### System

FIG. 1A is a diagram illustrating a population health management system 100, according to an embodiment. Population health management system 100 assesses patient health data against clinical guidelines to produce outputs. Outputs include, but are not limited to, identification of patients not meeting clinical guidelines, identification of patients meeting clinical guidelines, risk stratification of patients, identification of patient populations based on risk, demographics, practitioner, and clinical notifications to patients and practitioners. Additionally, population health management system 100 defines patient populations, identifies care gaps for patients, stratifies risks associated with at-risk patients, and provides a mechanism to engage patients to provide more robust and proactive health management. System 100 may actively engage patients in their own health outcomes. For example, high-risk patients partner with medical practitioners in their care coordination and treatment, while lower risk patients are directed to preventive interventions, including active personal health management. Additionally, population health management system 100 assists medical practitioners in the management of patient treatments and measures outcomes of clinical notifications to patients and treatment plans.

As explained in detail below, population health management system 100 dynamically applies clinical guidelines and predictive models across patient populations to identify care gaps and stratify risks. Additionally, system 100 accesses health information from many patients being served by many practitioners. With access to large volumes of patient health data for patients served by many practitioners, system 100 provides aggregated analytics related to patient medical conditions, outcomes, and treatments that can be compared across practitioners or against benchmarks.

Population health management system 100 includes four modules: population patient health data interface 120, notification module 150, reporting module 140 and population health management engine 110. Population health management engine 110 includes two submodules: real time processing engine 112 and non-real time processing engine 114. System 100 also includes three databases: patient health database 132, clinical guideline database 134, and population measurement database 136.

In general, patient health management system 100 operates as follows. Patient health data interface 120 receives patient health data, formats it uniformly, and stores it in patient health database 132. Patient health data interface 120 also transmits the patient health data to population health management engine 110. Population health management engine 110's real time processing engine 112 evaluates the data against criteria stored in clinical guideline database 134. If the data matches the criteria, notification module 150 sends a notification to the patient or to the patient's physician or other healthcare provider.

Separately from real time processing engine 112's assessment, non-real time processing engine 114 evaluates the patient health data stored in patient health database 132 to determine whether it meets criteria in clinical guideline database 134. As a result of this evaluation, non-real time processing engine 114 may determine ratios of patients within populations that meet the criteria in clinical guideline database 134. Then, non-real time processing engine 114 may store the determined ratios in population measurement database 136. The ratios are available to patients and their healthcare providers through reporting module 140. In addition, healthcare providers may receive the ratios as notifications via notification module 150. Each of these modules and its operation are discussed in detail below.

Patient health data interface 120 receives patient health data entries that are provided to population health management engine 110 for evaluation and processing. Patient health data interface 120 may, for example, receive data from an electronic health record system. Patient health data interface 120 accesses patient health data and structures the health data into a common data language. The common data language may include entries encoded using the Quality Data Model (QDM). In an embodiment, patient health data interface 120 may receive event changes and store the formatted information in patient health database 132 in a patient-specific log, as described below with respect to FIG. 1B.

FIG. 1B illustrates aspects of a patient health data interface 120, according to an embodiment. In FIG. 1B, patient health data interface 120 has three components: event receipt module 152, service bus 154, and event listener 156.

Event receipt module 152 receives that notifications when patient health information is generated, altered, or deleted. The events may occur, for example, when there are changes to a patient's diagnosis, medication, vaccination, labs, allergies, family history, risk factors (e.g., tobacco use), demographics, encounters, vitals, procedures, screening/assessment/interventions, referrals, and patient conditions. The events may be transmitted by different health databases whenever a patient's health data changes. They may be formatted, for example, as API requests. When a new event is received, events receipt module 152 receives data describing the change in stores the data on service bus 154.

Service bus 154 queues the incoming events. For example, service bus 154 may operate in a first-in-first-out manner to store incoming events and provide them to event listener 156.

Event listener 156 may be one or more threads of execution that watch for data on service bus 154. When data is available on service bus 154, event listener 156 takes the data off service bus 154 and uses it to alter a patient-specific file that describes the patient's health in a common format, such as the Quality Data Model, stored in patient health database 132.

Depending on the event data, event listener 156 may delete QDM entries for the patient. It may add new QDM entries for the patient. Or it may alter QDM existing entries for the patient. For example, if an API request is received by event receipt module 152 and queued on service bus 154 that indicates that a patient is no longer taking a particular medication, then event listener 156 would remove the QDM entry representing the medication from the patient-specific file. This may involve, for example, looking up the QDM code for that medication and deleting the QDM entry corresponding to that medication code and the patient's corresponding patient ID. In other examples, a single event may alter delete or remove multiple QDM entries.

In this way, by receiving events and queuing them on the service bus, embodiments obviate the need to individually query large number of databases. In particular, the relevant data is pushed to the first service bus and then to a patient specific table or data file, assembling all the data needed for clinical decision support in a single location. By having the data together in a single location, embodiments may enable clinical decision support over a large number of patients or within a greater amount of data than would be otherwise possible.

The QDM describes clinical concepts in a standardized format so individuals (e.g., providers, researchers, measure developers) monitoring clinical performance and outcomes can clearly and concisely communicate necessary information. The QDM may be specified by the Centers for Medicare and Medicaid Services.

Each QDM entry may represent a wide range of things, including diagnoses, medications, vitals, lab tests, encounters, procedures, allergies, referrals, family histories, patient and provider characteristics, and EHR-specific events. To represent these different things, an entry may include a variety of data points, including:
Category—The QDM category of the entry, or a custom category having a category specific to the EHR system being used.
Actor—An identification of the patient or provider involved.
Timing—A range of time for encounters and statuses (smoking status, etc.), or the single date a thing was requested, performed, or recorded.
Primary Code—The coding system used depends on the nature of the entry: diagnoses may be ICD9 or SNOMED codes; vitals may be LOINC codes; medications may be NDC or RXNORM codes; and EHR-specific entries may use custom codes that are specific to the EHR system being used.
Negation Flag—A flag set when the intent of the entry is to indicate that the defined event did not occur or the defined status was not true at a point in time
State—A type the entry. Some states document a request, some indicate that an action was performed, some encapsulate the result of a measurement, and some track whether or when a condition is active or a status present.

The combination of the category, state, and negation data points may define a class of the corresponding entry. This class may indicate that other optional data points may be present. The optional data points may include:
Attributes—Usually coded as SNOMED clinical terms, represents the nature of an entry, e.g. the reason for performing, the specific context in which an event occurred, or the coded result of a measurement. SNOMED is a systematically organized computer processable collection of medical terms providing codes, terms, synonyms, and definitions used in clinical documentation and reporting.
Value—The numeric result of a measurement or the quantity of a substance. The value may have an associated unit of measurement.
Context—A unique identifier for a group of events sharing a common thread. This may be a transcript identifier to correlate items that occur within the same encounter, or a message identifier to correlate multiple responses to the same originating request.
Tag—For measures that count specific occurrences of an event (e.g., number of office visits), instead of just unique patients, each countable entry can be assigned a tag that, when combined with the patient id, forms a unique identifier for the occurrence.

In this way, patient health data interface 120 structures incoming health information. After formatting the health information, patient health data interface 120 stores the information in patient health database 132 and sends it to population health management engine 110 for processing.

Returning to FIG. 1A, population health management engine 110 uses real time processing engine 112 to assess the formatted clinical information to provide clinical decision support. Real time processing engine 112 processes the formatted clinical information in real time in response to its receipt and formatting. To assess the formatted information, engine 112 interprets guidelines stored in clinical guideline database 134, for a single patient. The guidelines may include triggers indicating that clinical action may need to be taken. When criteria in the guidelines match the formatted information, engine 112 may initiate an action specified by the trigger. In one example, the clinical guidelines may trigger an action when a patient's systolic blood pressure exceeds 140 mm Hg. When engine 112 receives formatted clinical information indicating that the patient's systolic blood pressure is, for example, 150 mm Hg, engine 112 may signal notification module 150 to send a notification to the patient.

As mentioned above, clinical guideline database 134 stores clinical guidelines related to one or more medical conditions. The clinical guidelines stored within database 134 are provided to the population health management engine 110 and applied against patient health data entries in patient health database 132 for population health management engine 110 to generate various outputs.

The clinical guidelines may be stored in a scripting language that is set-based. A set-based scripting language may consume and create collections of things by examining the attributes of each thing, and the relationship between things. The things in question can take a variety of forms, and may together create a tuple, such as a relational algebra tuple. The language may support many relational operations like projection, selection, union, intersection, difference, semijoin, antijoin, count, sum, first, and last.

The clinical guidelines may stratify patients into patient groups. The stratification may be based on levels of risk to a medical condition. For example, for patients with a healthy weight, the clinical guidelines may trigger an action when engine 112 receives a blood pressure measurement above 140 mm Hg. But for obese patients, the threshold may lower. For obese patients, clinical guidelines may trigger an action when engine 112 receives a blood pressure measurement above only 130 mm Hg.

The clinical guidelines may be standard or may include rules specific to a particular practitioner. For example, a practitioner may specify rules that request notification whenever one of her patients' cholesterol is measured to be above a threshold, such as 200 mg/dL. Also, the practitioner may specify rules that trigger a notification when one of her patients meets a particular guideline. For example, a practitioner trying to help control a patient's blood pressure may request a notification when that patient's blood pressure drops below threshold, such as 180 mg/dL.

When engine 112 determines that the formatted clinical data received from patient health data interface 120 meets criteria stored in clinical guideline database 134, engine 112 signals notification module 150 to send a notification.

Notification module 150 sends a clinical notification that indicates the medical characteristics of the patient that violates or achieves a clinical guideline. The clinical notification may be sent to the patient or the patient's health practitioner. The notification may involve sending a text message or email indicating that a new notification is available. On receipt of the text message or email, the patient or health practitioner may log into a secure portal to review the notification. An example notification is illustrated in FIG. 4.

The notification may ask that the patient schedule an appointment with a practitioner. Notification module 150 may record whether the patient actually schedules an appointment in response to the notification to track response rates. Notification module 150 may use the patient's past response rate to determine whether to send future notifications to the patient. In this way, notification module 150 may throttle back on notifications likely to be ignored.

In addition to processing new data for individual patients as it comes in, population health management engine 110 also processes data across a population, such as a practitioner's patient roster, to determine a portion of the population that complies with the clinical guidelines in clinical guideline database 134. To generate this population data, population health management engine 110 uses non-real time processing engine 114. Non-real time processing engine 114 may execute periodically, such as nightly. On execution, engine 114 may, for each population, determine the ratio of patients in patient health database that comply with various guidelines in clinical guideline database 134 and store the ratios in population measurement database 136.

Engine 114 may operate by translating the scripted guidelines in clinical guideline database 134 into stored procedures, such as SQL stored procedures. A stored procedure may be a subroutine implemented on the database management system and may be available to applications that access a relational database system. For example, stored procedures can consolidate and centralize logic that was originally implemented in applications. Stored procedures may consolidate processing that would otherwise require engine 114 to execute of several SQL statements on database 132, into a single call to database 132's database management system. In that example operation, during periodic executions, engine 114 would operate by calling the stored procedures to return the population data.

When its periodic processing is complete, engine 114 stores the resulting population data to population measurement database 150. The population data may include several lists of patients, or possibly specific occurrences for a patient (when counting events as opposed to people). These several lists constitute the base population (Denominator), patients meeting a specific guidelines (Numerator), and patients with special circumstances (Exception and Exclusion). To attribute responsibility for the care of a patient to one or more providers, an attribution population may also be included. The attribution population is a set of provider-patient (or provider-occurrence) pairs. Finally, to assist in providing clinical decision support, an alert population may be used. The alert population may specify patients for which a clinical action is recommended. The types of populations that may be determined by engine 114 and stored in population measurement database 150 are below:

| Population | Description |
|---|---|
| Denominator | The set of patients, providers, or occurrences for which |
| | a given measurement is relevant. |
| Numerator | The set of patients, providers, or occurrences that meet the |
| | specified conditions being measured. Dividing the |
| | denominator by the numerator provides a proportional |
| | measurement. |
| Exclusion | The set of patients that have unusual circumstances that |
| | would make any measurement invalid. |
| Exception | The set of patients that have complications that make it |
| | difficult to meet the numerator goals, but should be counted |
| | if the numerator goals are met despite the complications. |
| Attribution | The set of provider-patient pairs, each pair assigning |
| | one or more providers as responsible for a given patient. |
| Alert | The set of patients for which a specific alter should be |
| | raised. |

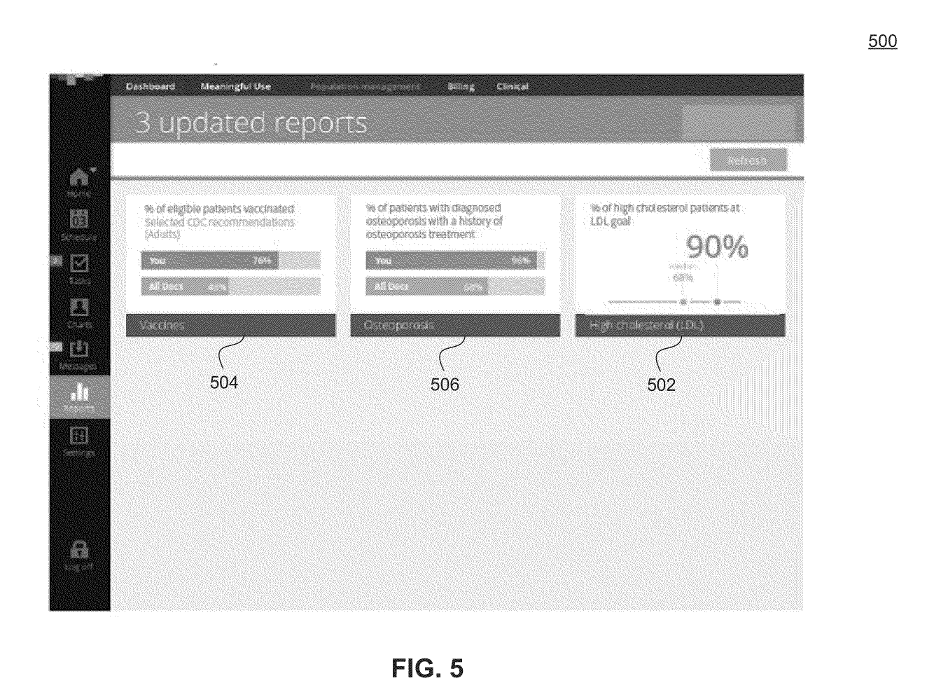

Once the population data is stored in population measurement database 136, reporting module 140 uses to the population data to generate reports. In an embodiment, these reports are provided through a practitioner dashboard. Example embodiments of a practitioner dashboard are illustrated in FIGS. 5-7.

In one embodiment, reporting module 140 may personalize a dashboard to a practitioner. In another embodiment, the practitioner dashboard may display a meta-dashboard with a summary panel for each available population management dashboard, and each population management dashboard may provide population management outputs related to a particular medical condition. In yet another embodiment, the population management dashboard may display outputs for patients of a particular practitioner compared to patients serviced by a set of other practitioners.

When a practitioner selects a portion of a dashboard, the dashboard may display more detailed information. For example, a dashboard may be configured to receive requests from a practitioner for more detailed information about one or more of the practitioner's patients. In response to the request, the dashboard may display health management information for the requested one or more of the practitioner's patients.

Measurements on the dashboard may each have a narrow clinical focus. Often, the measurements may be the ratio of the population of patients for which some condition is met over the population for which the condition should be met. The gap between the eligible population and those who are meeting the goal can be used as a trigger for notifications.

As described above, real time processing engine 112 conducts processing in real time to provide timely results for individual patients. But providing real time processing of population data may be costly on computing resources. At the same time, querying the raw data at the time a practitioner navigates to the dashboard may also slow response time. For at least that reason, non-real time processing engine 114 pre join and filters data between the patient health database 132 and clinical guideline database 134 and stores the resulting population data in population management database 136. By pre joining and filtering population before reporting them to the dashboard, embodiments avoid having to include this logic in the dashboard functions themselves and reduce the count and size of the records sent.

### Methods

FIG. 2 is a flowchart illustrating a method 200 for real time processing of patient health data. Method 200 begins by receiving health data for a patient at step 202. The health data may, for example, be a vitals measurement. In other examples, health data could be a diagnosis, medication, lab tests, patient-health practitioner encounter, procedure, allergy, referral, or family history.

At step 204, the health data is encoded using the quality data model (QDM). The encoded data is compared against clinical decision support (CDS) trigger criteria at step 206. As described above, these triggers may accord with clinical guidelines for that patient. When the criteria is met at decision block 208, one or more triggers are generated at step 210. The triggers may be sent to a notification to the patient or the patient's health practitioner, indicating that particular action should be taken, such as setting up an appointment with a health practitioner.

In an embodiment, method 200 is executed whenever new health data becomes available. In that way, by executing method 200 in real time, embodiments are able provide timely actionable advice, thereby improving healthcare.

FIGS. 3A-B are flowcharts illustrating methods for processing of population health data. FIG. 3A illustrates a method 300 that may be executed when new health data is received. Method 300 begins by receiving health data for patient step 302. At step 304, the health data is encoded using the quality data model (QDM). At step 306, the health data is stored.

FIG. 3B illustrates a method 350 that may be executed periodically, such as on a nightly basis, to generate population data. Method 350 begins by determining whether each health data point meets the clinical criteria at step 352. The amount of health data points, such as the number of patients, providers, or occurrences, that meets the criteria is summed to determine a numerator that step 354.

In addition to the numerator, a denominator is also determined at steps 356 and 358. The denominator is the total number of data points, such as the total number patients, providers, or occurrences, for which the measurement is relevant. At step 356, the health data is evaluated to determine whether it meets certain exclusionary criteria. For example, some patients may have conditions where some data, such as their cholesterol, may not be relevant. Those patients should be removed from the data set at decision block 356. The remaining patients are summed at step 358 to create the denominator.

With the numerator and denominator determined, a ratio, or proportional measurement, is generated at step 360. This proportional measurement indicates provides a metric indicative of the population's health. At step 362, the proportional measurement is stored and made available for reporting on health practitioner's dashboard.

In this way, by periodically conducting the necessary processing to determine population data, computing performance is improved.

### User Interfaces

FIG. 4 is a user interface diagram illustrating an example notification 400. Notification 400 includes a link 402 that, when selected, navigates the patient to a webpage to schedule an appointment with a health practitioner. In an example, notification 400 may be sent to a patient via email. In another example, an email may be sent to the patient indicating that a new notification is available the patient's secure portal.

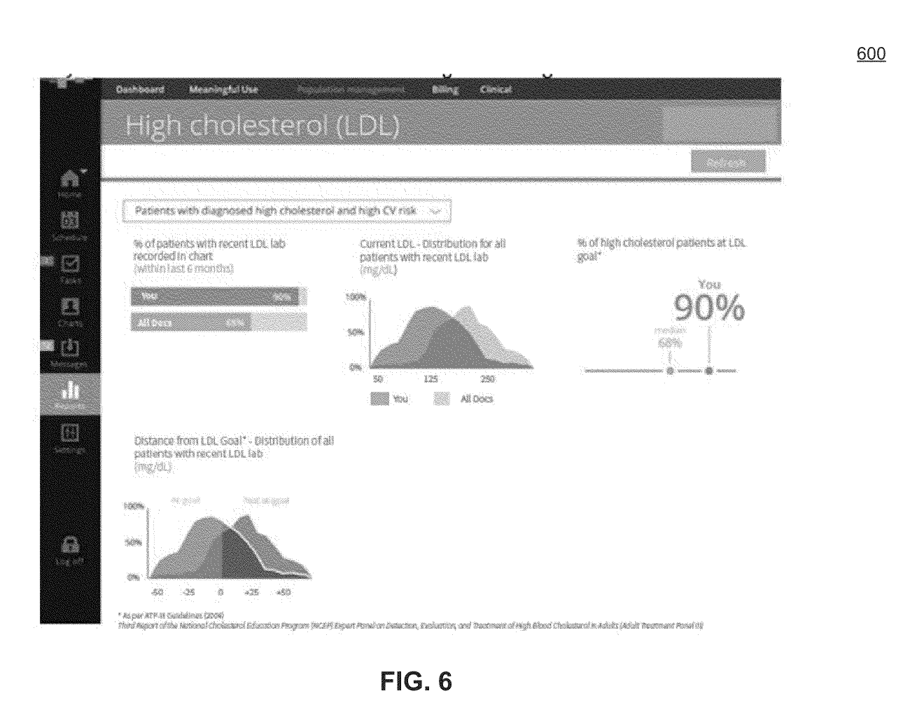

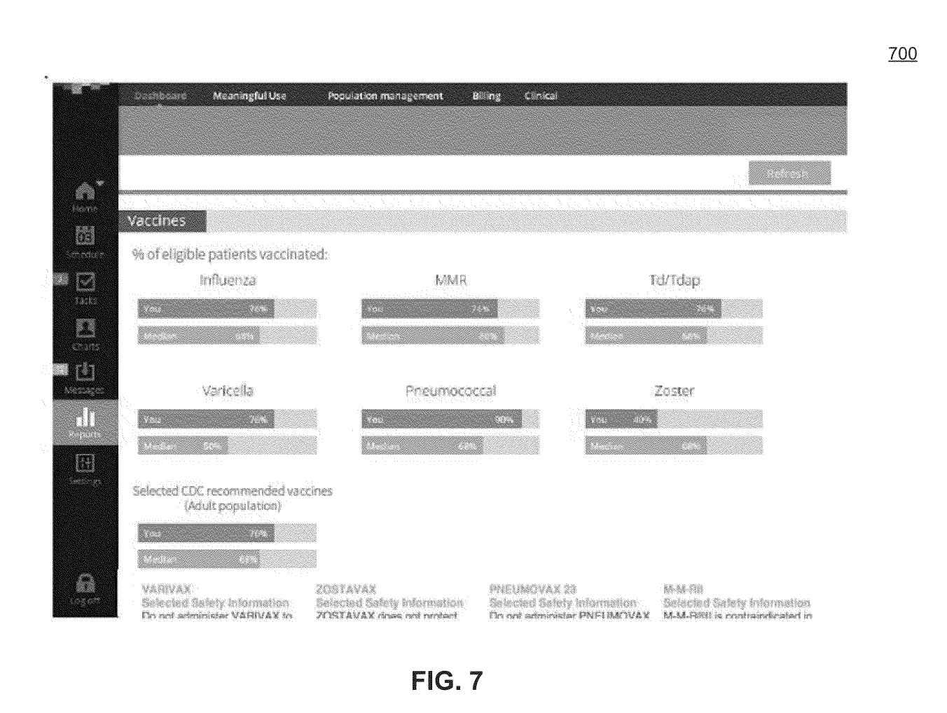

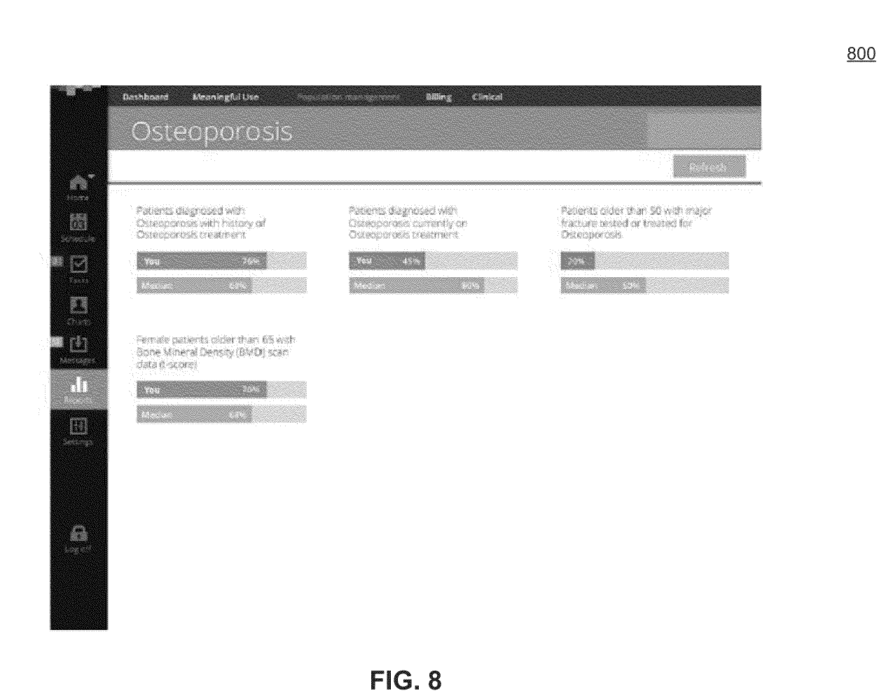

FIGS. 5-8 are user interface diagrams illustrating different views of a practitioner dashboard. FIG. 5 illustrates a view 500 providing an overview of different reports available to a health practitioner. This overview may be a meta-dashboard. View 500 indicates that the health practitioner has three updated reports and provides links to each. In particular, view 500 includes links 502, 504, and 506, each linking to a different report. Link 502, when selected, navigates the health practitioner to a view 600 in FIG. 6; link 504 navigates the health practitioner to a view 700 in FIG. 7; and link 506 navigates the health practitioner to a view 800 in FIG. 8.

FIG. 6's view 600 shows population health data on cholesterol levels. For example, it shows the percentage of high cholesterol patients meeting their low-density lipoprotein (LDL) goal. It also compares the percentage among the physician's high cholesterol patients to the overall percentage of high cholesterol patients meeting their LDL goal. Comparing these two numbers may provide a useful metric in assessing the quality of care. In addition to percentages, view 600 illustrates the distribution of LDL levels among the relevant patients. The distributions are illustrated using both the patients' LDL level and the degree of variance from the patients' respective LDL goal.

FIG. 7's view 700 illustrates a percentage of the practitioner's patients vaccinated for various diseases and compares those to median percentages overall. View 700 illustrates vaccination rates for influenza, MMR, Td/Tdap, varicella, pneumococcal, and zoster. It also illustrates the rate of adults having selected vaccines that the Center for Disease Control (CDC) recommend.

FIG. 8's view 800 illustrates population health data related to osteoporosis. It illustrates the percentage of: (i) patients diagnosed with osteoporosis with a history of osteoporosis treatment; (ii) patients diagnosed with osteoporosis currently on osteoporosis treatment; (iii) patients older than 50 with major fracture tested or treated for osteoporosis; and (iv) female patients older than 65 with bone mineral density (BMD) scan data (T-score). In addition to the percentages for patients in the practitioner's practice, view 800 also illustrates median percentages for each of these osteoporosis population health data points.

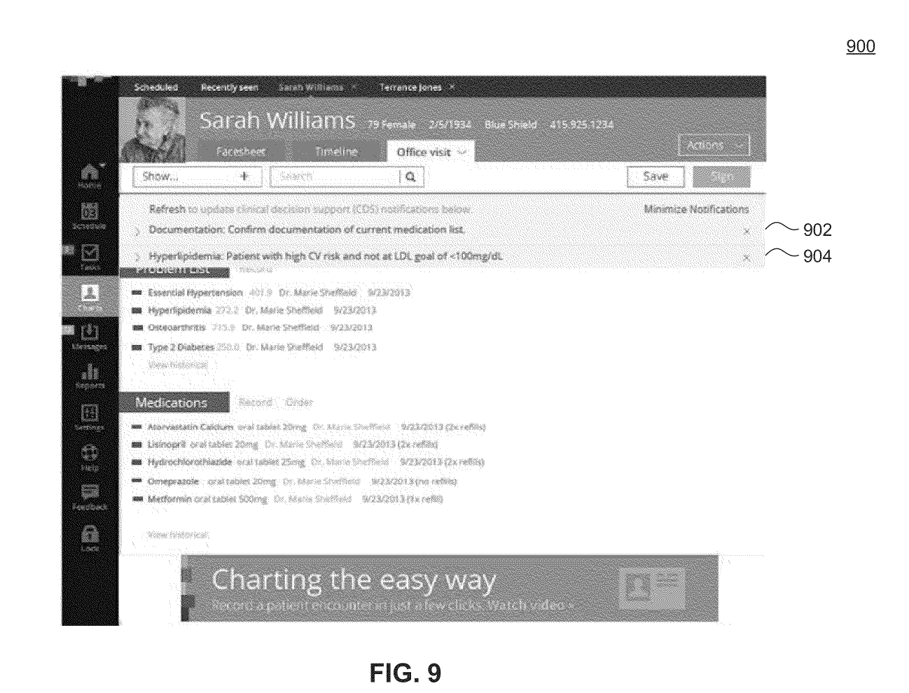

In addition to the physician dashboard, the patient may also have a dashboard. The patient's dashboard may only include data specific to that patient. FIG. 9 is user interface diagram illustrating a patient dashboard 900. Patient dashboard 900 includes links 902 and 904. Selecting one of those links may navigate the user to a corresponding notification, such as the one illustrated in FIG. 4.

### Example Computing Devices

Each of the engines, interfaces and modules in FIGS. 1A and B may be implemented on the same or different computing devices in hardware, software, or any combination thereof. Such computing devices can include, but are not limited to, a personal computer, a mobile device such as a mobile phone, workstation, embedded system, game console, television, set-top box, or any other computing device. Further, a computing device can include, but is not limited to, a device having a processor and memory, including nontransitory memory, for executing and storing instructions. The memory may tangibly embody the data and program instructions. Software may include one or more applications and an operating system. Hardware can include, but is not limited to, a processor, memory, and graphical user interface display. The computing device may also have multiple processors and multiple shared or separate memory components. For example, the computing device may be a part of or the entirety of a clustered computing environment or server farm.

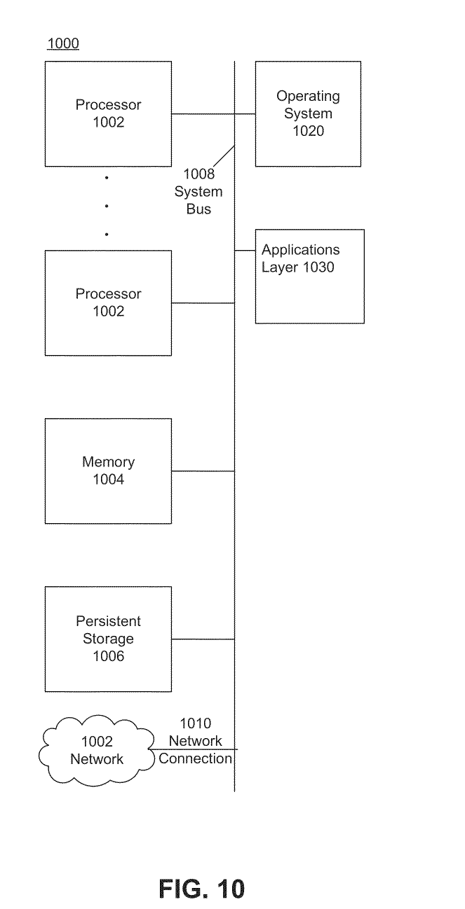

An example computing device is illustrated in FIG. 10. FIG. 10 is a diagram illustrating a computing device 1000 that accesses a network over a network connection 1010 that provides computing device 1000 with telecommunications capabilities. Computing device 1000 uses an operating system 1020 as software that manages hardware resources and coordinates the interface between hardware and software.

In an embodiment, computing device 1000 contains a combination of hardware, software, and firmware constituent parts that allow it to run an applications layer 1030. Computing device 1000, in embodiments, may be organized around a system bus 1008, but any type of infrastructure that allows the hardware infrastructure elements of computing device 1000 to communicate with and interact with each other may also be used.

Processing tasks in the embodiment of FIG. 10 are carried out by one or more processors 1002. However, it should be noted that various types of processing technology may be used here, including multi-core processors, multiple processors, or distributed processors. Additional specialized processing resources such as graphics, multimedia, or mathematical processing capabilities may also be used to aid in certain processing tasks. These processing resources may be hardware, software, or an appropriate combination thereof. For example, one or more of processors 1002 may be a graphics-processing unit (GPU). In an embodiment, a GPU is a processor that is a specialized electronic circuit designed to rapidly process mathematically intensive applications on electronic devices. The GPU may have a highly parallel structure that is efficient for parallel processing of large blocks of data, such as mathematically intensive data common to computer graphics applications, images and videos.

To manipulate data in accordance with embodiments describe herein, processors 1002 access a memory 1004 via system bus 1008. Memory 1004 is nontransitory memory, such as random access memory (RAM). Memory 1004 may include one or more levels of cache. Memory 1004 has stored therein control logic (i.e., computer software) and/or data. For data that needs to be stored more permanently, processors 1002 access persistent storage 1006 via system bus 1008. Persistent storage 1006 may include, for example, a hard disk drive and/or a removable storage device or drive. A removable storage drive may be an optical storage device, a compact disc drive, flash memory, a floppy disk drive, a magnetic tape drive, tape backup device, and/or any other storage device/drive.

Processors 1002, memory 1004, and persistent storage 1006 cooperate with operating system 1020 to provide basic functionality for computing device 1000. Operating system 1020 provides support functionality for applications layer 1030.

Network connection 1010 enables computer device 1000 to communicate and interact with any combination of remote devices, remote networks, remote entities, etc. For example, network connection 1010 may allow computer device 1000 to communicate with remote devices over network 102, which may be a wired and/or wireless network, and which may include any combination of LANs, WANs, the Internet, etc. Control logic and/or data may be transmitted to and from computer device 1000 via network connection 1010.

Applications layer 1030 may house various modules and components. For example, the applications and modules in FIGS. 1A and B may be included in applications layer 1030.

It should be noted that computer-readable medium embodiments may include any physical medium which is capable of encoding instructions that may subsequently be used by a processor to implement methods described herein. Example physical media may include floppy discs, optical discs (e.g. CDs, mini-CDs, DVDs, HD-DVD, Blu-ray), hard drives, punch cards, tape drives, flash memory, or memory chips. However, any other type of tangible, persistent storage that can serve in the role of providing instructions to a processor may be used to store the instructions in these embodiments.

### CONCLUSION

Identifiers, such as “(a),” “(b),” “(i),” “(ii),” etc., are sometimes used for different elements or steps. These identifiers are used for clarity and do not necessarily designate an order for the elements or steps.

In this detailed description, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A system for population health management, comprising:
a computing device;
a clinical guideline database that includes clinical guidelines related to one or more medical conditions;
a patient health data interface, implemented on the computing device, that receives patient health data entries;
a population health management engine implemented on the computing device, that generates outputs based at least upon patient health data entries and clinical guidelines; and
a practitioner communications module, implemented on the computing device, that presents outputs that the population health management engine generates and enables a practitioner to interact with the system.

2. The system of claim 1, further comprising a notification module, implemented on the computing device, that provides clinical notifications to patients based at least on an output from the population health management engine.

3. The system of claim 2, wherein the notification module transmits a clinical notification to a patient upon a determination by the population health management engine that a medical characteristic of the patient violates a clinical guideline.

4. The system of claim 3, wherein the clinical notification indicates the medical characteristics of the patient that violates a clinical guideline and requests that a patient schedule an appointment with a practitioner.

5. The system of claim 3, wherein the population health management records response rates of a patient scheduling an appointment in response to a clinical notification.

6. The system of claim 5, wherein the population health management engine factors a patient's response rate to prior clinical notifications into a determination whether to send a clinical notification to the patient.

7. The system of claim 2, wherein the patient communications module transmits a clinical notification to a patient upon a determination by the population health management engine that a medical characteristic of the patient complies with a clinical guideline.

8. The system of claim 7, wherein the clinical notification informs the patient that the patient has achieved the clinical guideline.

9. The system of claim 1, wherein the population health management engine stratifies patients into patient groups.

10. The system of claim 9, wherein the stratification is based on levels of risk to a medical condition.

11. The system of claim 1, wherein the reporting module generates a practitioner dashboard that is personalized to the practitioner and displays outputs generated by the population health management engine on a practitioner computing device.

12. The system of claim 11, wherein the practitioner dashboard displays a meta dashboard with a summary panel for each available population management dashboard, where a population management dashboard provides population management outputs related to a particular medical condition.

13. The system of claim 12, wherein a population management dashboard displays outputs for patients of a particular practitioner compared to patients serviced by a set of other practitioners.

14. The system of claim 12, wherein a population management dashboard is configured to receive requests from a practitioner for more detailed information about one or more of the practitioner's patients and displays health management information for the requested one or more of the practitioner's patients.

15. The system of claim 12, wherein a population management dashboard displays clinical decision support notifications on a per patient basis.

16. The system of claim 1, further comprising a practitioner rules database.

17. A method for determining population health data, comprising:
(a) receiving heath data for a patient;
in response to receipt of the heath data:
(b) storing the patient's health data in a patient health database;
(c) determining whether the patient's health data meets criteria specified in clinical guidelines;
(d) when the heath data is determined to meet the criteria in (c), providing a notification to the patient;
periodically:
(e) comparing health data for a population stored in the patient health database to criteria specified in the clinical guidelines to determine which portion of the population meets the clinical guidelines;
(f) storing, in a population measurement database, a specification of the portion of the population determined in (e); and
(g) on request for a health practitioner's dashboard, retrieving, from the population measurement database, information representing health of a population of patients in the health practitioner's practice to present the information representing health of the population in a view to the heath practitioner, wherein the periodic comparing (e) and storing (f) enable efficient retrieval (g).

18. The method of claim 17, wherein the comparing (e) comprises:
(i) determining an amount of patient data stored in the patient health database that meets a criterion specified in clinical guidelines as a numerator value;
(ii) determining an amount of patient data stored in the patient health database for which the criterion in clinical guidelines is relevant as a denominator value; and
(iii) determining the specification of the portion of the population to be a ratio of the numerator value to the denominator value.

19. The method of claim 18, wherein the comparing (e) further comprises:
(v) determining an amount of patient data stored in the patient health database that represents patents having a circumstance that would make measurement for the criterion invalid; and
(vi) excluding from the numerator and dominator the amount determined in (v).

20. The method of claim 18, wherein the comparing (e) further comprises:
(v) determining which patients have complications that create difficulty in meeting the criterion; and
(vi) for each patient in (v), excepting from the numerator and dominator corresponding patient data only when the patient data fails to meet the criterion.

21. A program storage device tangibly embodying a program of instructions executable by at least one machine to perform a method for determining population health data, comprising:
(a) receiving heath data for a patient;
in response to receipt of the heath data:
(b) storing the patient's health data in a patient health database;
(c) determining whether the patient's heath data meets criteria specified in clinical guidelines;
(d) when the heath data is determined to meet the criteria in (c), providing a notification to the patient;
periodically:
(e) comparing health data for a population stored in the patient health database to criteria specified in the clinical guidelines to determine which portion of the population meets the clinical guidelines;
(f) storing, in a population measurement database, a specification of the portion of the population determined in (e); and
(g) on request for a health practitioner's dashboard, retrieving, from the population measurement database, information representing health of a population of patients in the health practitioner's practice to present the information representing health of the population in a view to the heath practitioner, wherein the periodic comparing (e) and storing (f) enable efficient retrieval (g).

22. The program storage device of claim 21, wherein the comparing (e) comprises:
(i) determining an amount of patient data stored in the patient health database that meets a criterion specified in clinical guidelines as a numerator value;
(ii) determining an amount of patient data stored in the patient health database for which the criterion in clinical guidelines is relevant as a denominator value; and
(iii) determining the specification of the portion of the population to be a ratio of the numerator value to the denominator value.

23. The program storage device of claim 22, wherein the comparing (e) further comprises:
(v) determining an amount of patient data stored in the patient health database that represents patents having a circumstance that would make measurement for the criterion invalid; and
(vi) excluding from the numerator and dominator the amount determined in (v).

24. The program storage device of claim 22, wherein the comparing (e) further comprises:
(v) determining which patients have complications that create difficulty in meeting the criterion; and
(vi) for each patient in (v), excepting from the numerator and dominator corresponding patient data only when the patient data fails to meet the criterion.

25. A system for population health management, comprising:
a computing device;
a clinical guideline database that includes clinical guidelines related to one or more medical conditions;
a patient health data interface, implemented on the computing device, that (i) receives a plurality of event notifications, each describing updates to a patient's health data in a different heath databases and (ii) stores the data from patient's health data from in a patient-specific file;
a population health management engine, implemented on the computing device, that generates outputs based at least upon the patient-specific file and the clinical guidelines; and
a practitioner communications module, implemented on the computing device, that presents outputs that the population health management engine generates and enables a practitioner to interact with the system.

26. The system of claim 25, wherein the patient health data interface comprises:
a service bus including a queue;
an event receipt module that receives the plurality of event notifications and queues the event notifications on the service bus; and
an event listener that retrieves the event notifications from the queue and formats the event notification for storage in the patient-specific file.

27. The system of claim 26, wherein the wherein the patient-specific file uses a Quality Data Model (QDM) format to encode data describing the patient's health.
